(19) United States
(12) Patent Application Publication
(10) Pub. No.: US 2008/0087507 A1
(43) Pub. Date: Apr. 17, 2008

(54) Disc brake assembly and method of assembly

(75) Inventors: Antonio Eduardo DeMorais, South Lyon, MI (US); Harry D. Miller, Canton, MI (US); Charles Giacomazza, Plymouth, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(73) Assignee: Kelsey-Hayes Company

(21) Appl. No.: 11/580,578

(22) Filed: Oct. 13, 2006

(51) Int. Cl. F16D 65/38

(52) U.S. Cl. 188/73.39; 188/73.45

(57) ABSTRACT

This invention relates to an improved disc brake assembly. The disc brake assembly includes a member adapted to be secured to a vehicle component, the member having a pair of ears each provided with at least a first opening formed therethrough; a brake caliper supported relative to the member; a pair of brake shoes carried by the brake caliper, each of the brake shoes including opposed ends having an opening formed therethrough; and a pin disposed in each of the first openings of the ears and extending through the openings formed in the opposed ends of the brake shoes to slidably support the brake shoes and the caliper for movement relative to the member whereby the brake caliper and the brake shoes may be removed from the member without removing the pins from the member.

### CROSS REFERENCE TO RELATED APPLICATIONS

The present application is related to co-pending U.S. application Ser. No. 11/474,830.

### BACKGROUND OF THE INVENTION

This invention relates in general to vehicle drum and disc brake assemblies and in particular to an improved structure for a disc service brake adapted for use in a vehicle disc brake assembly.

Most vehicles are equipped with a brake system for slowing or stopping movement of the vehicle in a controlled manner. A typical brake system for an automobile or light truck includes a disc brake assembly for each of the front wheels and either a drum brake assembly or a disc brake assembly for each of the rear wheels. In some instances, the disc brake assembly can be a “drum-in-hat” type of disc brake assembly. The brake assemblies are actuated by hydraulic or pneumatic pressure generated when an operator of the vehicle depresses a brake pedal. The structures of these drum brake assemblies and disc brake assemblies, as well as the actuators therefore, are well known in the art.

A typical drum-in-hat type of disc brake assembly includes a hydraulically or pneumatically actuated disc service brake and a mechanically actuated drum-in-hat parking and emergency brake. The disc service brake includes a rotor which is secured to the wheel of the vehicle for rotation therewith. The rotor includes a pair of opposed friction plates which are selectively engaged by portions of a caliper assembly. The interior of the rotor defines a cylindrical braking surface.

A caliper assembly is slidably supported by pins secured to a mounting flange. The mounting flange is secured to a non-rotatable component of the vehicle, such as the steering knuckle or the axle flange. The caliper assembly includes a pair of brake shoes which are disposed on opposite sides of the rotor. The brake shoes are operatively connected to one or more hydraulically actuated pistons for movement between a non-braking position, wherein they are spaced apart from the opposed friction plates of the rotor, and a braking position, wherein they are moved into frictional engagement with the opposed friction plates of the rotor. When the operator of the vehicle depresses the brake pedal, the piston urges the brake shoes from the non-braking position to the braking position so as to frictionally engage the friction plates of the rotor and thereby slow or stop the rotation of the associated wheel of the vehicle.

The drum-in-hat parking and emergency brake includes a pair of opposed arcuate brake shoes which are supported on a backing plate for selective movement relative thereto. The backing plate is secured to the mounting flange, or alternatively, can be formed integral therewith. Each of the brake shoes has a friction pad or lining secured thereto. The brake shoes extend within the cylindrical braking surface of the rotor. To effect parking and emergency braking action, the operator of the vehicle manually pulls an actuating lever. The lever is connected to an actuation cable having a park brake cable end which, when pulled, actuates a mechanical actuating mechanism. The actuating mechanism is located adjacent one of the ends of the brake shoes and is operative to move the brake shoes outwardly apart from one another such that the friction pads frictionally engage the cylindrical braking surface of the rotor. Such frictional engagement causes slowing or stopping of the rotational movement of the rotor and, therefore, the wheel of the vehicle in a controlled manner.

### SUMMARY OF THE INVENTION

This invention relates to an improved disc brake assembly. The disc brake assembly includes a member adapted to be secured to a vehicle component, the member having a pair of ears each provided with at least a first opening formed therethrough; a brake caliper supported relative to the member; a pair of brake shoes carried by the brake caliper, each of the brake shoes including opposed ends having an opening formed therethrough; and a pin disposed in each of the first openings of the ears and extending through the openings formed in the opposed ends of the brake shoes to slidably support the brake shoes and the caliper for movement relative to the member whereby the brake caliper and the brake shoes may be removed from the member without removing the pins from the member.

### BRIEF DESCRIPTION OF THE DRAWINGS

FIG. 1 is a perspective view of a portion of a first embodiment of a vehicle disc brake assembly.

FIG. 2 is an exploded perspective view of a portion of the first embodiment of the vehicle disc brake assembly illustrated in FIG. 1.

FIG. 3 is an exploded perspective view of the first embodiment of the vehicle disc brake assembly showing the first step in the installation process thereof.

FIG. 4 is an exploded perspective view of the first embodiment of the vehicle disc brake assembly showing the second step in the installation process thereof.

FIG. 5 is an exploded perspective view of the first embodiment of the vehicle disc brake assembly showing the third step in the installation process thereof.

FIG. 6 is a perspective view of the assembled first embodiment of the vehicle disc brake assembly.

FIG. 7 is an exploded perspective view of the first embodiment of the vehicle disc brake assembly showing the first step in the servicing process thereof.

FIG. 8 is an exploded perspective view of the first embodiment of the vehicle disc brake assembly showing the second step in the servicing process thereof.

FIG. 9 is an exploded perspective view of the first embodiment of the vehicle disc brake assembly showing the third step in the servicing process thereof.

FIG. 10 is a perspective view of a portion of a second embodiment of a vehicle disc brake assembly.

FIG. 11 is a perspective view of a portion of a third embodiment of a vehicle disc brake assembly.

### DETAILED DESCRIPTION OF THE INVENTION

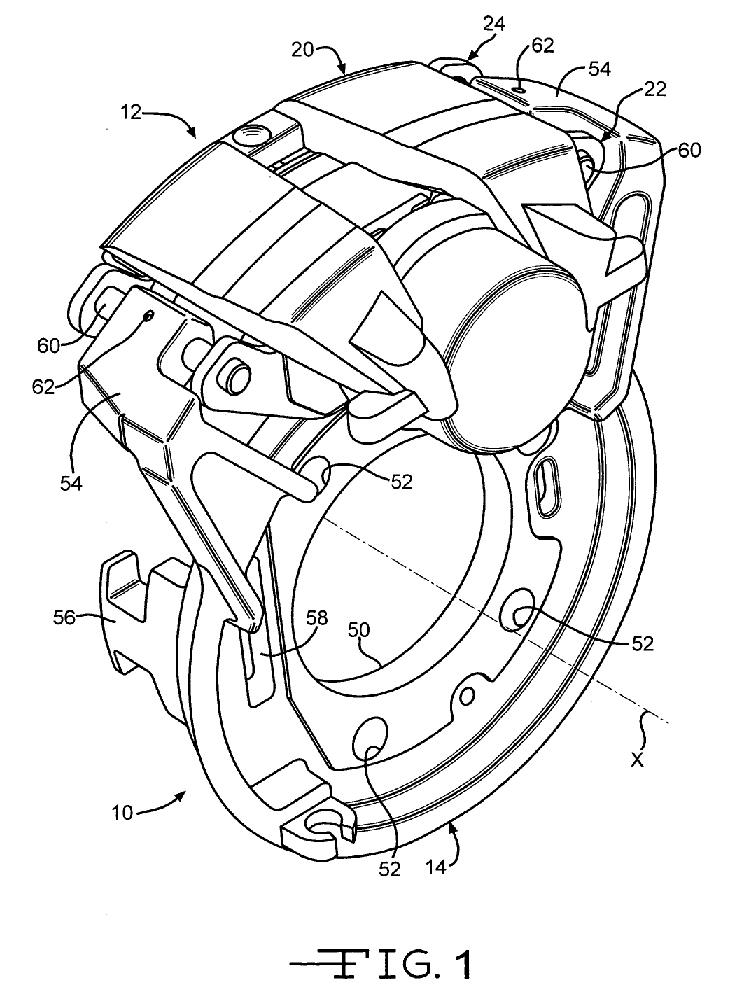

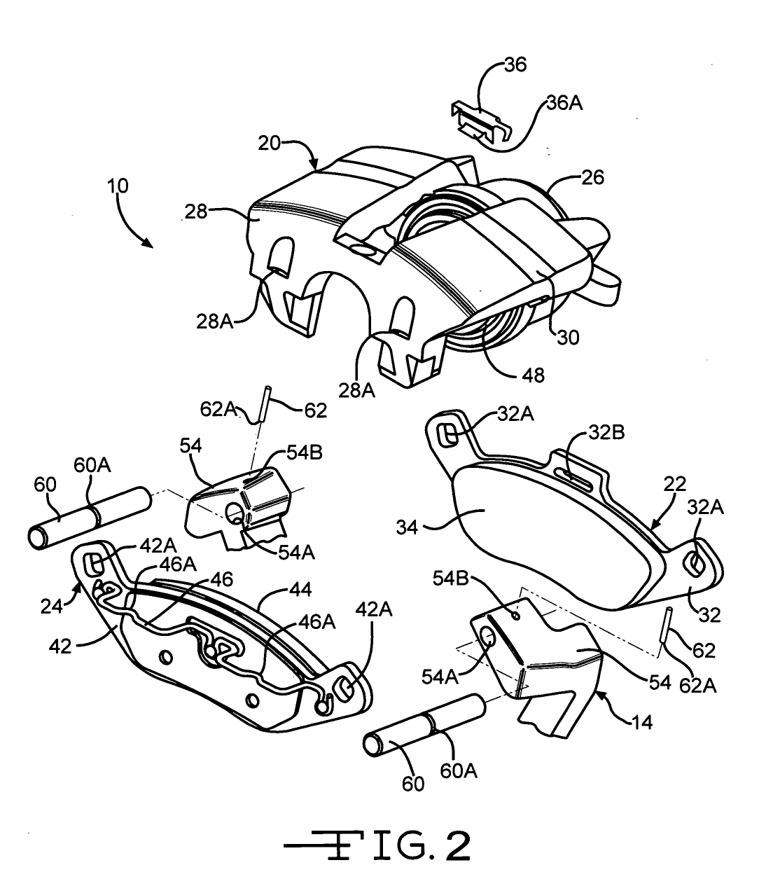

Referring now to the drawings, there is illustrated in FIGS. 1 and 2 a portion of a first embodiment of a vehicle disc brake assembly, indicated generally at 10. In the illustrated embodiment, the vehicle disc brake assembly 10 is a drum-in-hat disc brake assembly and includes a disc service brake, indicated generally at 12 in FIG. 1, and a drum-in-hat parking and emergency brake (not shown in the drawing figures but is known in the art and may be similar to that shown in U.S. Pat. No. 6,729,444 to Schmandt et al. and U.S. Pat. No. 6,681,902 to Siekas et al., the disclosure of these patents incorporated by reference in entirety herein). The general operation of the vehicle drum-in-hat disc brake assembly 10 is conventional in the art. Thus, only those portions of the vehicle drum-in-hat disc brake assembly 10 which are necessary for a full understanding of this invention will be explained and illustrated in detail. Also, although this invention will be described and illustrated in connection with the particular vehicle drum-in-hat disc brake assembly 10 disclosed herein, it will be appreciated that this invention may be used in connection with other types of vehicle drum-in-hat disc brake assemblies. In addition, this invention may be used in connection with other types of vehicle disc brake assemblies (i.e., disc brake assemblies not having the drum-in-hat parking and emergency brake portion). For example, the invention may be used in conjunction with other single piston, twin piston, single opposed piston and twin opposed piston disc brake assemblies, such as shown for example in U.S. Pat. No. 6,725,981 to Franz and U.S. Pat. No. 6,719,705 to Wemple, the disclosure of these patents incorporated by reference in entirety herein.

As shown in one or both of FIGS. 1 and 2, the vehicle drum-in-hat disc brake assembly 10 includes the disc service brake 12, an adapter 14, and a brake rotor 16. In the illustrated embodiment, the disc service brake 12 includes a generally C-shaped caliper 20, a first or inboard brake shoe 22 and a second or outboard brake shoe 24. The caliper 20 includes an inboard leg portion 26 and an outboard leg portion 28 which are interconnected by an intermediate bridge portion 30.

The inboard brake shoe 22 includes a backing plate 32 and a friction pad 34. The inboard backing plate 32 includes opposed ends having openings 32A formed therein. In the illustrated embodiment, the openings 32A have a generally square-like shape. The inboard backing plate 32 further includes an opening 32B formed therein. The opening 32B is adapted to receive a tab 36A of a shoe retention clip 36. As will be discussed below, the clip 36 is adapted to removably secure or support the inboard brake shoe 22 to the inboard leg portion 22 of the caliper 20 for assembling and servicing purposes. In the illustrated embodiment, the opening 34B is an elongated opening. Alternatively, inboard brake shoe 22 may be removably secured to the caliper 20 by other suitable means if so desired.

The outboard brake shoe 24 includes a backing plate 42 and a friction pad 44. The outboard backing plate 42 includes opposed ends having openings 42A formed therein. In the illustrated embodiment, the openings 42A have a generally square-like shape. The outboard brake shoe 24 further includes a shoe retention spring 46 secured thereto. As will be discussed below, the retention spring 46 is adapted to removably secure the outboard brake shoe 24 to the outboard leg portion 28 of the caliper 20 for assembling and servicing purposes.

Preferably, as shown in the illustrated embodiment, the retention spring 46 is permanently attached to the outboard backing plate 42 by suitable means. To accomplish this in the illustrated embodiment, the spring 46 is attached to the outboard backing plate 42 by peening over a plurality of tabs or projections provided thereon. Alternatively, the retention spring 46 may be secured, either permanently or removably, to the outboard backing plate 42 by other suitable means if so desired. Also, the outboard brake shoe 24 may be removably secured to the caliper 20 by other suitable means if so desired. Alternatively, the shape, construction and/or supporting of one or both of the inboard brake shoe 22 and the outboard brake shoe 24 can be other than illustrated and described herein if so desired.

The disc service brake 12 includes an actuation means (not shown) for effecting the operation thereof. In the illustrated embodiment, the actuation means includes a brake piston 48, partially shown in FIG. 2, which is disposed in a counterbore or recess formed in the inboard leg portion 26 of the caliper 20. The actuation means may be hydraulic, electrical, pneumatic, and mechanical types.

In the illustrated embodiment, the adapter 14 (only partially shown in FIG. 2), is shown as being a one-piece casting and is preferably adapted to be secured to a fixed, non-rotatable component of the vehicle, such as an axle flange (not shown) or a steering knuckle (not shown) for enclosing a rotatable axle (not shown). To accomplish this, the adapter 14 includes a relatively large opening 50, and a plurality of smaller lug bolt mounting holes 52 (partially shown in FIG. 1), formed therein about the opening 50. The opening 50 permits an outer end of the rotatable axle to extend therethrough to the vehicle wheel (not shown) and a brake rotor (discussed below), which are secured to the axle for rotation therewith in a known manner. Suitable fasteners, such as for example lug bolts (not shown), are disposed in the lug bolt mounting holes 52 to secure the adapter 14 to the associated vehicle component. Alternatively, the adapter 14 need not be formed as a separate adapter which is secured to the axle flange or steering knuckle or other suitable vehicle component but may be formed as a part of the axle flange or steering knuckle or other suitable vehicle component, preferably, in a one-piece casting, if so desired.

In the illustrated embodiment, the adapter 14 defines an axis X and further includes a pair of outwardly extending ears or lugs 54 and an abutment 56. Each of the ears 54 is provided with a first opening 54A and a second opening 54B formed therein. The first opening 54A is an axially extending opening and is preferably formed completely through the ear 54. The second opening 54B is a radially extending opening and is formed at least to extend into and intersect with the first opening 54A.

In the illustrated embodiment, both the first opening 54A and the second opening 54B preferably have a circular shape; the second opening 54B preferably extends only to intersect with the first opening 54A; and the second opening 54B preferably is of a smaller diameter than the first opening 54A. In the illustrated embodiment, the adapter 14 further includes a generally elongated slotted opening 58. The slotted opening 58 is adapted to allow a lever member (not shown) of a parking brake and emergency brake actuation mechanism (not shown) to extend therethrough to actuate the brake shoes (not shown) of the parking and emergency brake in a know manner. Alternatively, the shape or construction of the adapter 14 may be other than illustrated if so desired. For example, the adapter 14 may be other than a one piece casting and/or the abutment 56 may be a separate part secured to the adapter 14 if so desired.

The disc service brake 12 further includes a pair of shoe slider pins 60, which are operatively secured to the adapter 14, and which are operative to slidably support the inboard brake shoe 22 and the outboard brake shoe 24, and therefore the caliper 20, relative to the adapter 14. In the illustrated embodiment, the shoe slider pins 60 are round smooth pins having a recess or groove 60A formed therein.

In the illustrated embodiment, each of the shoe slider pins 60 is operatively secured to the adapter 14 by a retention pin 62. To accomplish this, the retention pins 62 are preferably driven into the second holes 54B in an interference or press fit therewith so that ends 62A thereof are permanently disposed in the recesses 60A of the shoe slider pins 60. Alternatively, the shoe slider pins 60 may be secured, either permanently or removably, to the adapter 14 by other suitable means if so desired. For example, if it is desired to removably secure the shoe slider pins 62 to the adapter 14, a suitable removable faster, such as a screw (not shown), may be used. In either instance, once installed, the shoe slider pins 60 extend through the holes 32A and 42A of the brake shoes 22 and 24, respectively, to operatively support the brake shoes 22 and 24, and therefore the caliper 20, for sliding movement relative to the adapter 14 in both the outboard direction (to the left in FIG. 2) and the inboard direction (to the right in FIG. 2). Such sliding movement of the caliper 20 occurs when the disc service brake 12 is actuated.

The vehicle drum-in-hat disc assembly 10 further includes a brake rotor 62, which is connected to the wheel and axle of the vehicle for rotation therewith. The illustrated brake rotor 62 includes a pair of opposed friction discs 62A and 62B which extend radially outwardly between the inboard friction pad 22 and the outboard friction pad 24.

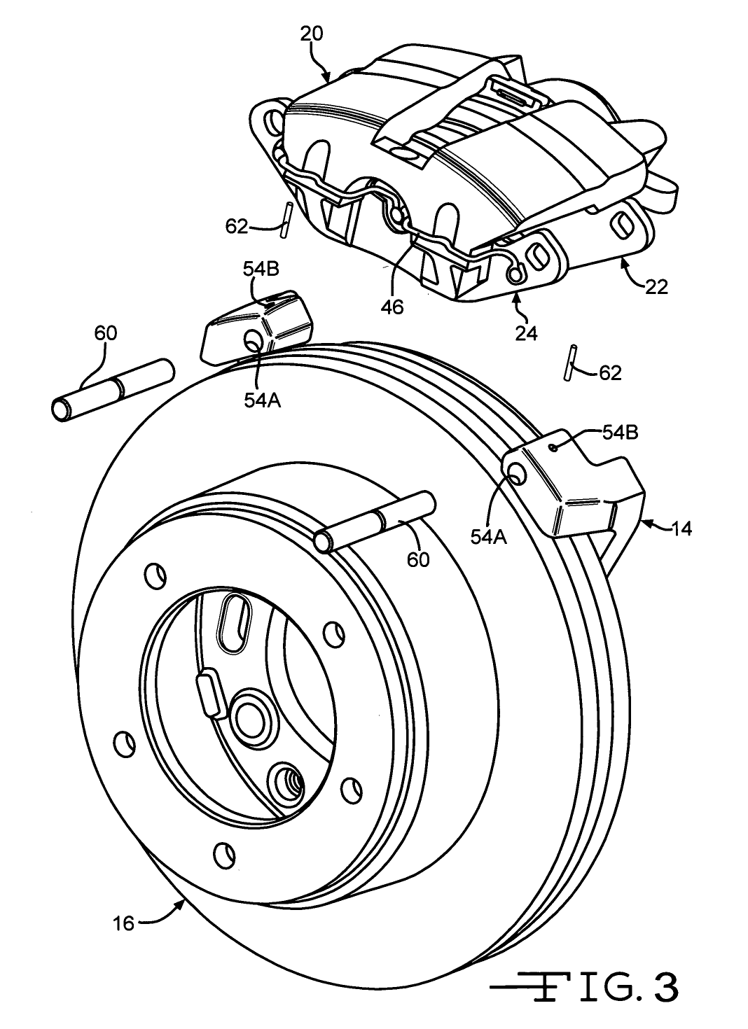

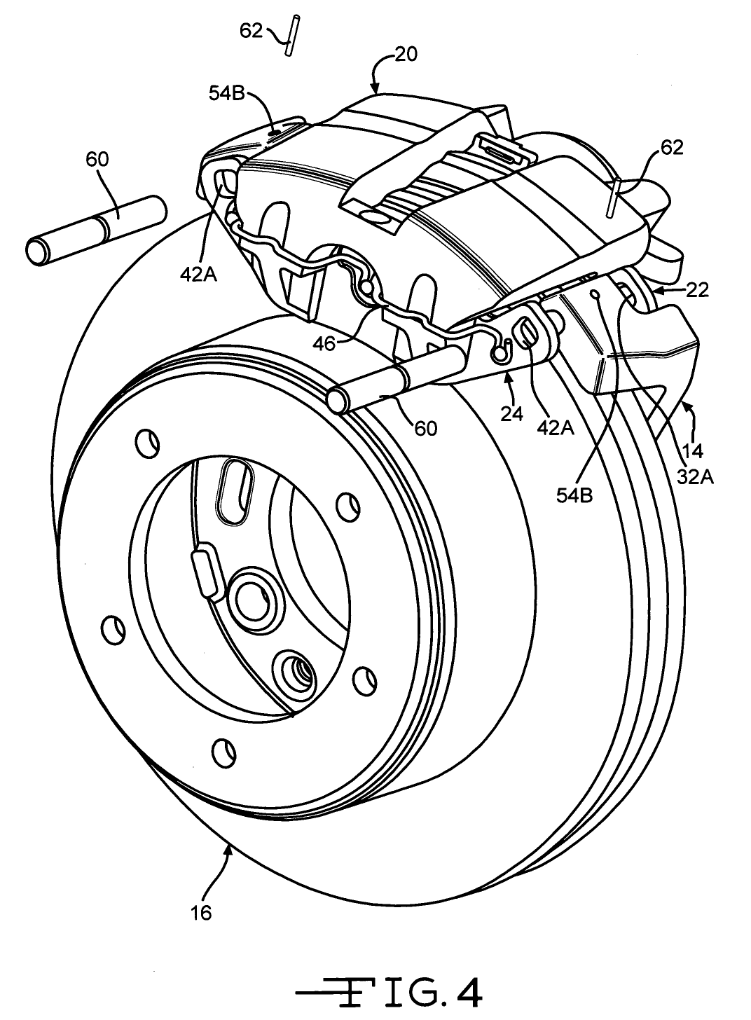

Turning now to FIGS. 3-6, the process for the initial installation of the disc service brake 12 of the vehicle drum-in-hat disc brake assembly 10 at a vehicle assembly plant will be discussed. First, as shown in FIG. 3, with the adapter 14 and the brake rotor 16 secured to the vehicle (not shown), the brake shoes 22 and 24 secured to the caliper 20 in the manner described above, and the shoe slider pins 60 and the retention pins 62 as loose parts, the caliper 20 is installed onto the adapter 14 and the rotor 16 as shown in FIG. 4. As shown in FIG. 4, the holes 42A and 32A of the backing plates 42 and 32, respectively, are aligned with the first holes 54A of the ears 54 of the adapter 14.

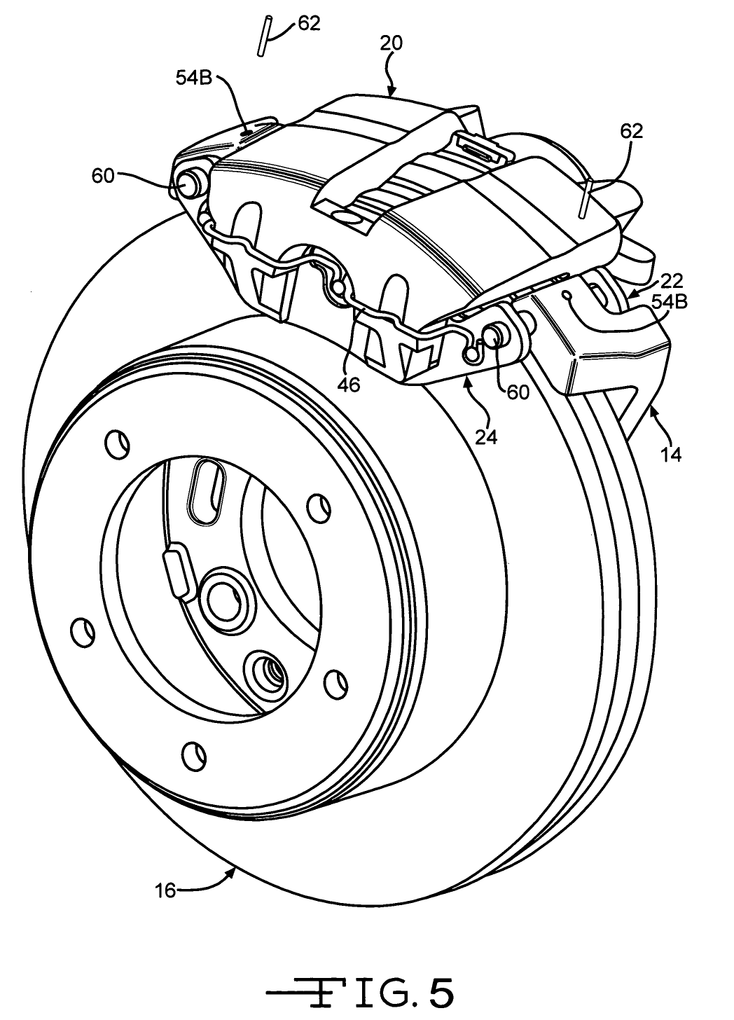

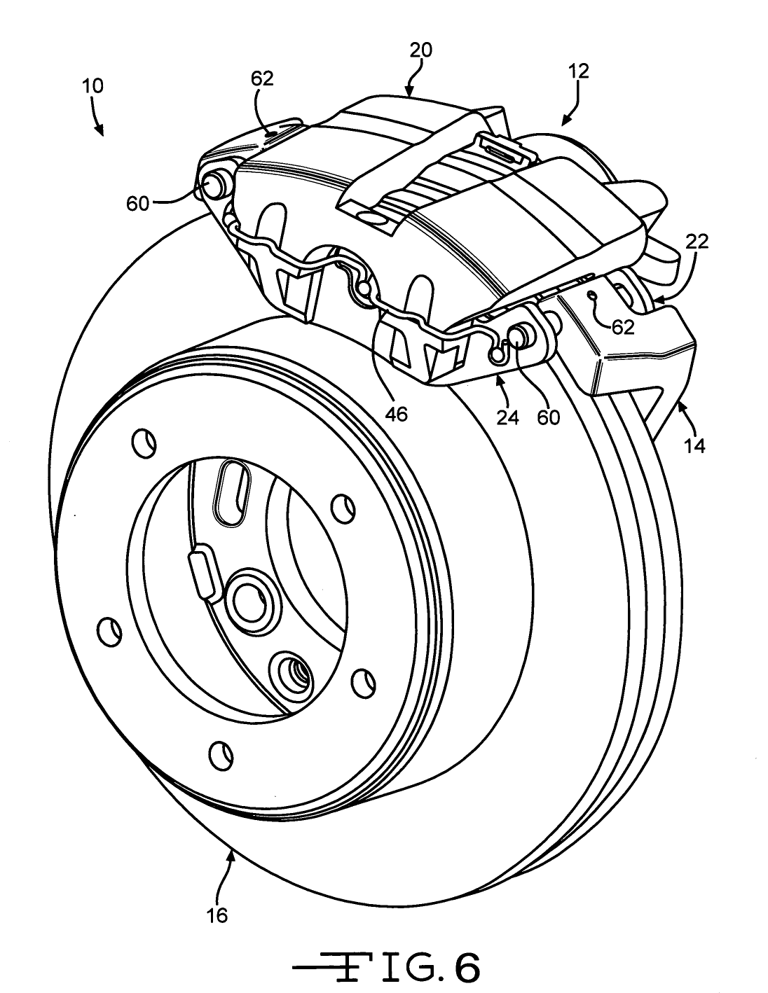

Next, as shown in FIG. 5, the shoe slider pins 60 are installed through the holes 42A of the outboard backing plate 42, through the first holes 54A of the ears 54 of the adapter 14, and through the holes 32A of the inboard backing plate 22 with the groove 60A in the shoe slider pins 60 aligned with the second holes 54B of the ears 54 of the adapter 14. Following this, as shown in FIG. 6, the retention pins 62 are preferably driven into the second holes 54B of the ears 54 of the adapter 14 to secure the shoe slider pins 60, and therefore the caliper 20, to the adapter 14 and complete the installation of the disc service brake 12 onto the vehicle.

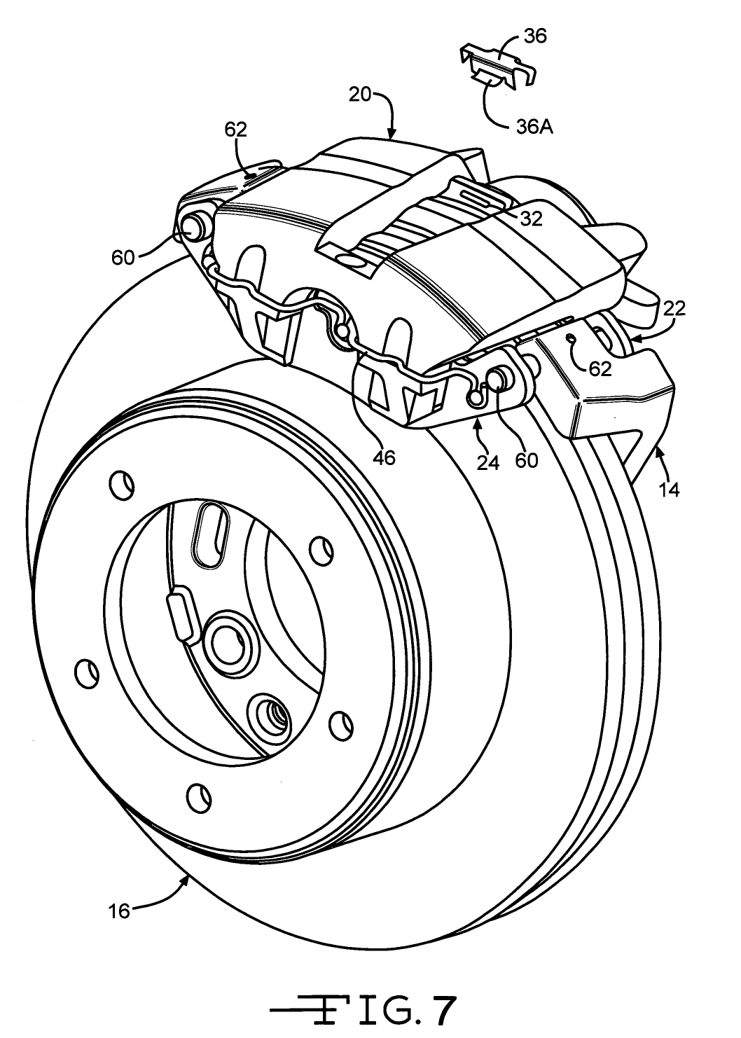

Turning now to FIGS. 7-9, the process for servicing the disc service brake 12 of the vehicle drum-in-hat disc brake assembly 10 will be discussed. First, as shown in FIG. 7, the shoe retention clip 36 is removed from the opening 32B of the backing plate 32 of the inboard brake shoe 22.

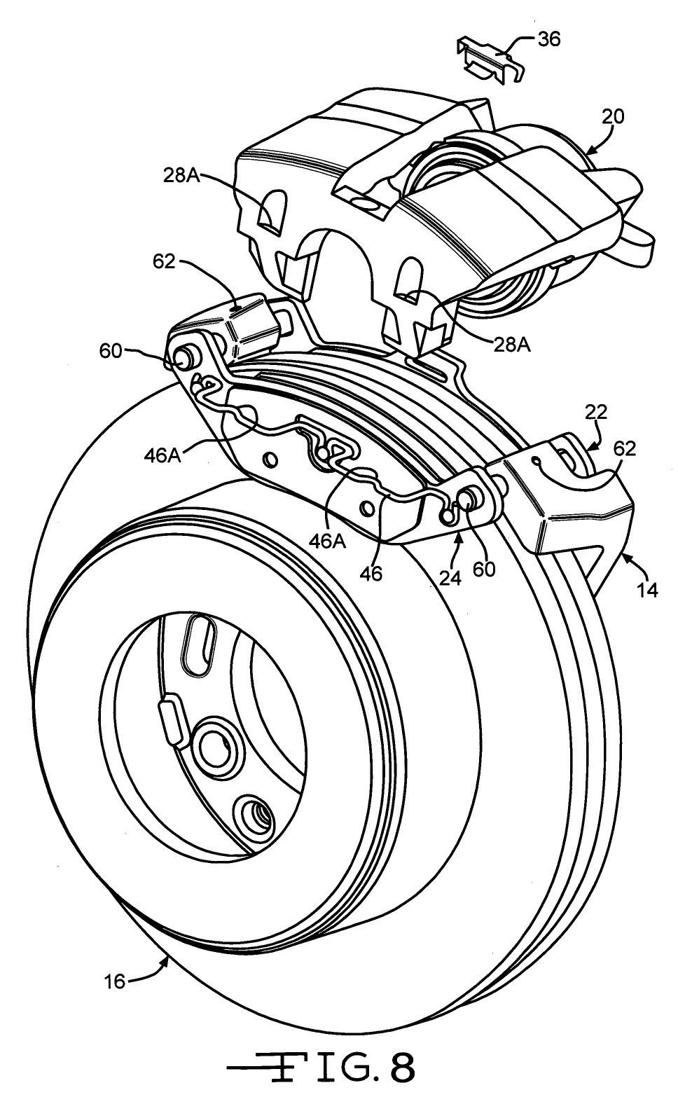

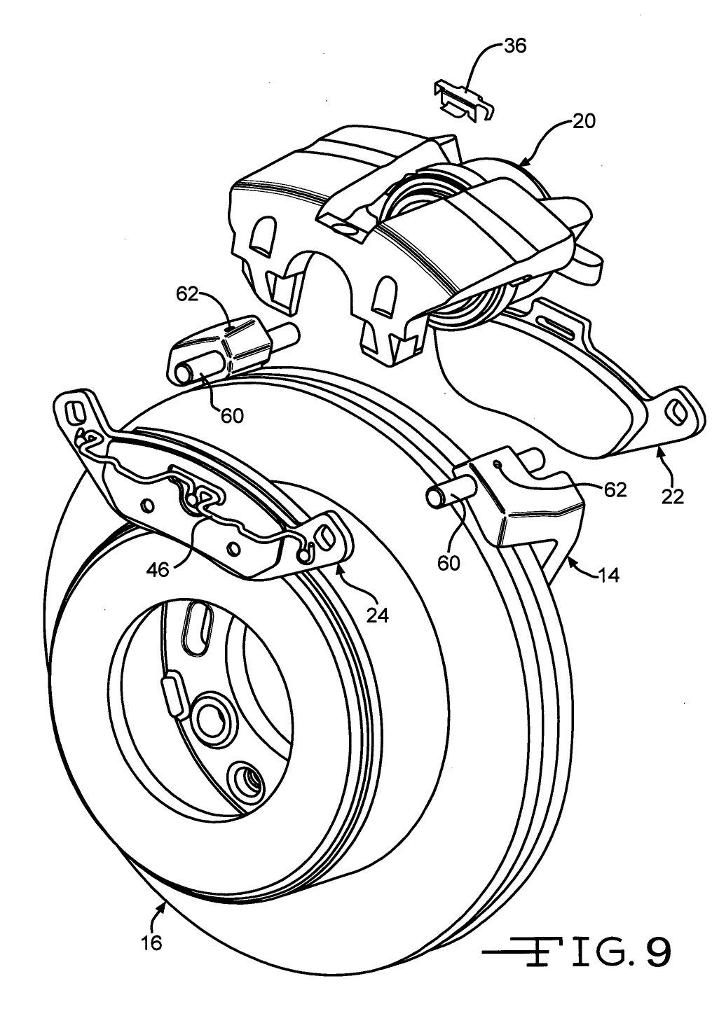

Next, as shown in FIG. 8, the caliper 20 is lifted off of the adapter 14. To accomplish this in the illustrated embodiment, the shoe retention spring 44 is moved or biased away from engagement with the outboard leg portion 28 of the caliper 20. Specifically, spring portions 46A are biased away from engagement with inwardly extending cut-outs 28A formed in the outboard leg portion 28 of the caliper 20. Following this as shown in FIG. 9, with the caliper 20 removed, one or both of the shoes 22 and 24 may be removed from the shoe slider pins 60 and replaced with new shoes. As can be seen in FIG. 9, the shoes 22 and 24 can be removed and replaced without having to remove the shoe slider pins 60 from the adapter 14.

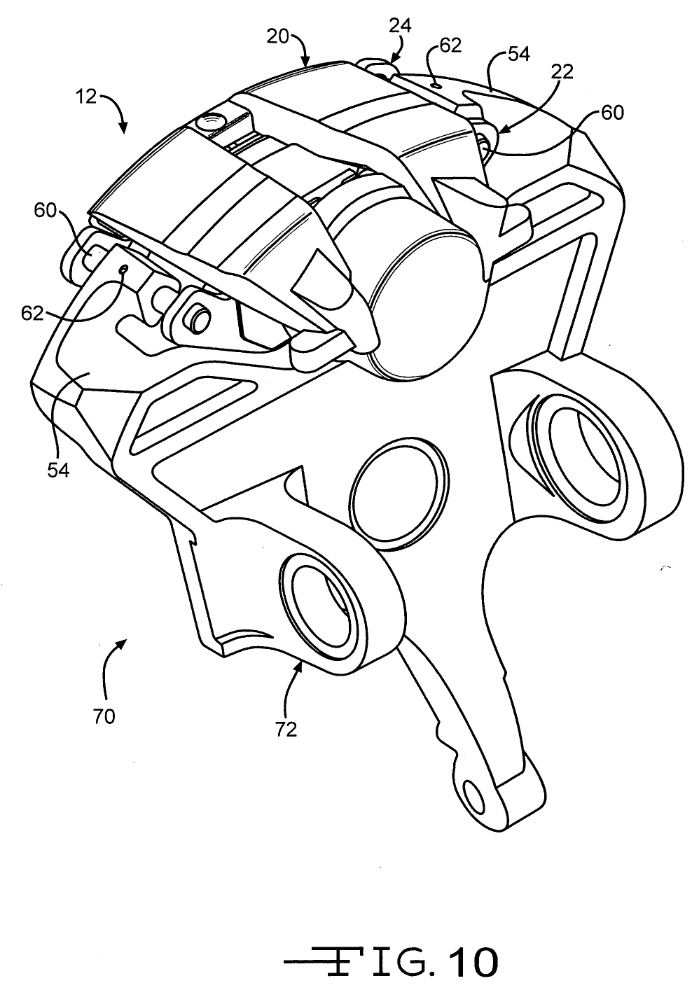

Turning now to FIG. 10 and using like reference numbers to indicate corresponding parts, there is illustrated a portion of a second embodiment of a vehicle disc brake assembly, indicated generally at 70. In the illustrated embodiment, a steering knuckle 72 is preferably formed as a one-piece casting for use on a front axle of the vehicle. Thus, in this embodiment, the steering knuckle 72 does not include an abutment 56 for the drum-in-hat parking and emergency brake like that shown in connection the adapter 14 in the embodiment of FIG. 1. However, the steering knuckle 72 may be for use on a rear axle of the vehicle in a drum-in-hat type of disc brake assembly and include an abutment 56 like that shown in connection with the embodiment of FIG. 1, wherein the abutment is 56 is integrally formed therewith, or alternatively, the steering knuckle 72 may have an abutment which is formed separately therefrom and secured thereto by suitable means if so desired.

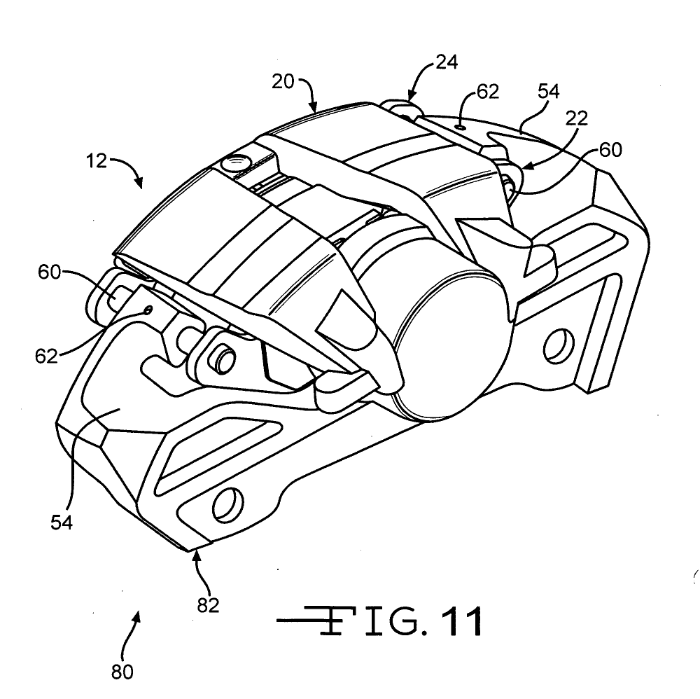

Turning now to FIG. 11 and using like reference numbers to indicate corresponding parts, there is illustrated a portion of a third embodiment of a vehicle disc brake assembly, indicated generally at 80. In the illustrated embodiment, an adapter or mounting member 82 is preferably formed as a one-piece casting for use on a front axle of the vehicle and may be secured to a suitable vehicle component, such as a steering knuckle (not shown). Thus, in this embodiment the adapter 82 does not include an abutment 56 for the drum-in-hat parking and emergency brake like that shown in connection the adapter 14 in the embodiment of FIG. 1. However, the adapter 82 may be for use on a rear axle of the vehicle in a drum-in-hat type of disc brake assembly and include an abutment 56 like that shown in connection with the embodiment of FIG. 1, wherein the abutment is 56 is integrally formed therewith, or alternatively, the adapter 82 may have an abutment which is formed separately therefrom and secured thereto by suitable means if so desired.

In accordance with the provisions of the patent statues, the principle and mode of operation of this invention have been described and illustrated in its various embodiments. However, it must be understood that the invention may be practiced otherwise than as specifically explained and illustrated without departing from the scope or spirit of the attached claims.

What is claimed is:

1. A disc brake assembly comprising:
a member adapted to be secured to a vehicle component, said member having a pair of ears each provided with at least a first opening formed therethrough;
a brake caliper supported relative to said member;
a pair of brake shoes carried by said brake caliper, each of said brake shoes including opposed ends having an opening formed therethrough; and
a pin disposed in each of said first openings of said ears and extending through said openings formed in said opposed ends of said brake shoes to slidably support said brake shoes and said caliper for movement relative to said member whereby said brake caliper and said brake shoes may be removed from said member without removing said pins from said member.

2. The disc brake assembly of claim 1 wherein said pin disposed in each of said first openings of said ears is permanently disposed therein.

3. The disc brake assembly of claim 1 wherein said pin disposed in each of said first openings of said ears is removably disposed therein.

4. The disc brake assembly of claim 1 wherein each of said brake shoes is carried by said caliper by a retention member.

5. The disc brake assembly of claim 4 wherein said retention members include a first retention member secured to one of said brake shoes, and which is operative to removably carry said one brake on said caliper, and a second retention member secured to the other one of said brake shoes, and which is operative to removably carry said other one of said brake shoes on said caliper.

6. The disc brake assembly of claim 1 wherein said pair of brake shoes includes an inboard brake shoe and an outboard brake shoe, said inboard brake shoe disposed inboard relative to said member and said outboard brake shoe disposed outboard relative to said member.

7. The disc brake assembly of claim 1 wherein said member is an adapter of a drum-in-hat disc brake assembly and said disc brake assembly is a disc service brake of said drum-in-hat disc brake assembly.

8. The disc brake assembly of claim 1 wherein said member is a steering knuckle.

9. The disc brake assembly of claim 1 wherein each of said ears of said member further includes a second opening formed therein, each of said second openings extending into said ears and intersecting said first openings, and wherein a pin retention member is disposed in each of said second openings and engages and retains said pins in said first openings of said ears of said member.

10. The disc brake assembly of claim 9 wherein said first openings are generally axial extending openings and said second openings are generally radially extending openings.

11. The disc brake assembly of claim 1 wherein said pair of brake shoes includes an inboard brake shoe and an outboard brake shoe, said inboard brake shoe disposed inboard relative to said member and said outboard brake shoe disposed outboard relative to said member, and wherein said inboard brake shoe and said outboard brake shoe are each carried by said caliper by a retention member.

12. The disc brake assembly of claim 1 wherein said member includes one of an integrally formed abutment or a separately formed abutment secured thereto.

13. A disc brake assembly comprising:
a member adapted to be secured to a vehicle component, said member having a pair of ears each provided with at least a first opening formed therethrough;
a brake caliper supported relative to said member;
a pair of brake shoes carried by said brake caliper by a retention member, each of said brake shoes including opposed ends having an opening formed therethrough, said pair of brake shoes including an inboard brake shoe and an outboard brake shoe, said inboard brake shoe disposed inboard relative to said member and said outboard brake shoe disposed outboard relative to said member; and
a pin disposed in each of said first openings of said ears and extending through said openings formed in said opposed ends of said brake shoes to slidably support said brake shoes and said caliper for movement relative to said member whereby said brake caliper and said brake shoes may be removed from said member without removing said pins from said member.

14. A method of assembling a disc brake assembly comprising the steps of:
(a) providing a member adapted to be secured to a vehicle component, the member having a pair of ears each provided with an opening formed therethrough;
(b) providing a brake caliper having a pair of brake shoes carried thereby, each of the brake shoes including opposed ends having an opening formed therethrough;
(c) moving the brake caliper relative to the member whereby the openings in the opposed ends of the brake shoes are aligned with the openings in the member;
(d) providing a pair of pins; and
(e) installing a pin in each of the aligned openings of the member and the openings of the opposed ends of the brake shoes to thereby slidably support the brake shoes and caliper for movement relative to the member and complete the assembly of the disc brake assembly.

15. The method of claim 14 wherein in step (e) the pins are one of permanently secured to the member or removably secured to the member.

16. The method of claim 14 wherein in step (b) each of the brake shoes is carried by the caliper by a retention member.

17. The method of claim 16 wherein the retention members include a first retention member secured to one of the brake shoes, and which is operative to removably carry the one brake on the caliper, and a second retention member secured to the other one of the brake shoes, and which is operative to removably carry the other one of the brake shoes on the caliper.

18. The method of claim 14 wherein in step (b) the pair of brake shoes includes an inboard brake shoe and an outboard brake shoe, and wherein after step
(c) is performed the inboard brake shoe is disposed inboard relative to the member and the outboard brake shoe is disposed outboard relative to the member.

19. The method of claim 14 wherein in step (a) each of the ears of the member further includes a second opening formed therein, each of the second openings extending into the ears and intersecting the first openings, and following step (e) the installing a pin retention member in each of the second openings to engage and retain the pins installed in the first openings during step (e).

20. The method of claim 19 wherein the first openings are generally axial extending openings and the second openings are generally radially extending openings.
